(19) United States
(12) Patent Application Publication
(10) Pub. No.: US 2025/0031051 A1
(43) Pub. Date: Jan. 23, 2025

(54) COMMUNICATIONS NETWORK NODE, NETWORK ELEMENTS, LAWFUL INTERCEPTION SYSTEM AND METHODS

(71) Applicant: Telefonaktiebolaget LM Ericsson (publ), Stockholm (SE)

(72) Inventors: Daniele GAITO, Pagani (IT); Giuseppe CELOZZI, Napoli (IT); Francesco ATTANASIO, Roccapiemonte (SA) (IT)

(21) Appl. No.: 18/708,991

(22) PCT Filed: Nov. 10, 2021
(86) PCT No.: PCT/EP2021/081213

§ 371 Date: May 9, 2024

(51) Int. Cl. H04W 12/80; H04W 12/08; H04W 76/14

(52) U.S. Cl. CPC H04W 12/80; H04W 12/08; H04W 76/14

(57) ABSTRACT

A communications network node (100) operable to: receive a sidelink connection request from a user equipment, UE, including an identification of at least one other UE involved in the sidelink; determine that the UE is a target UE to be monitored for lawful interception, LI, purposes; inform the target UE and the at least one other UE of a UE-to-UE direct communication interface frequency to use for the sidelink; send a request message to the at least one other UE requesting it to provide information about the sidelink connection and a copy of communications data exchanged on the sidelink connection to the node; send to an access and mobility management function, AMF, network element, NE, an information message including information about the sidelink connection received from the at least one other UE; and send to a user plane function, UPF, NE content messages including a copy of communications data exchanged on the sidelink connection received from the at least one other UE.

### TECHNICAL FIELD

The invention relates to a lawful interception, LI, system. The invention further relates to a communications network node, a communications network device hosting an access and mobility management function, AMF, network element, NE, and a communications network device hosting a user plane function, UPF, NE. The invention further relates to a communications network user equipment, UE. The invention further relates to a method of LI in a communications network and to a method of LI at a UE.

### BACKGROUND

ETSI standard GR NFV-SEC 011 V1.1.1, in particular section 6.2.1, describes a high-level architecture for lawful interception in a virtualized environment. Entities are logically represented, therefore it does not necessary reflect separate physical entities. The LI system comprises a Law Enforcement Agency, LEA, network and a Communications Service Provider, CSP, network. LEA is an organization authorized by a lawful authorization based on the applicable jurisdiction to request and receive the results of telecommunications interceptions of an interception target. The target is a person of interest and/or user equipment possessed or used by the person of interest being surveyed by the LEA. The LEA communicates with the CSP network through a network interface, called Handover Interface, HI. LEA comprises a Warrant Issuing Authority/Warrant Issuing Authority device and a Law Enforcement Monitoring Facility, LEMF. The Warrant Issuing Authority issues an intercept request, e.g., lawful authorization or warrant to the CSP through a first Handover Interface, HI1. The LEMF collects the intercepted information of the interception target. The LEMF communicates with an LI site through a second Handover Interface, HI2, for receiving Intercept Related Information, IRI, and through a third Handover Interface, HI3, for receiving Content of Communication, CC. Interfaces HI1, HI2, and HI3 are specified in more detail in the ETSI TS 102 232-1 V3.21.1 standard, “Lawful Interception (LI); Part 1: Internal Network Interface X1 for Lawful Interception”.

The LI site comprises an LI Administration Function, ADMF, and a Mediation and Delivery Function, MF/DF. The LI ADMF communicates with the MF/DF through an X1_2 interface and an X1_3 interface. IRI are collection of information or data associated with telecommunications services involving the interception target identity, specifically call associated information or data (e.g., unsuccessful call attempts), service associated information or data (e.g., service profile management by subscriber) and location information. The CC is information exchanged between two or more users of a telecommunications service, excluding IRI. The MF receives IRI and CC and transforms them from internal interface format to Handover Interface format. The DF will then handle dispatching of said data to the one or more designated LEAs.

Sidelink is an alternative short-range connectivity for mobile users that has been proposed for the vehicle-to-everything, V2X, use case. The communication involves vehicles, roadside infrastructure, and pedestrians. 3GPP standard 17 TS 23.287 V17.1.0 (September 2021) defines a 5G New Radio, NR, sidelink over PC5 reference point. This supports unicast, groupcast and broadcast communication, and hybrid automatic repeat request (hybrid-ARQ) retransmissions can be used for scenarios that require more robust communication. Groups can be either configured or formed, and the group members communicate using groupcast transmissions. Communication on a sidelink connection cannot currently be monitored.

### SUMMARY

It is an object to enable lawful interception, LI, of a target user equipment, UE, that is involved in a sidelink connection.

A first aspect provides a communications network node comprising interface circuitry, at least one processor and memory comprising instructions which when performed by the at least one processor cause the node to perform the following operations. An operation of receiving a sidelink connection request from a user equipment, UE. The sidelink connection request includes an identification of at least one other UE involved in the sidelink connection. An operation of determining that the UE is a target UE. A target UE is a UE to be monitored for lawful interception, LI, purposes. An operation of informing the target UE and the at least one other UE of a UE-to-UE direct communication interface frequency to use for the sidelink connection. An operation of sending a request message to the at least one other UE. The request message requests the at least one other UE to provide to the node information about the sidelink connection and a copy of communications data exchanged on the sidelink connection. An operation of sending to an access and mobility management function, AMF, network element, NE, an information message including information about the sidelink connection received from the at least one other UE. An operation of sending to a user plane function, UPF, network element, NE, content messages including a copy of communications data exchanged on the sidelink connection received from the at least one other UE.

The communications network node enables LI monitoring of a target UE that is involved in a sidelink connection, including monitoring of information about the sidelink connection and monitoring of communications data exchanged on the sidelink connection.

In an embodiment, the operation of determining that the UE is a target UE comprises the following operations. An operation of sending to the AMF NE a permission request requesting permission for the UE to be involved in a sidelink connection. An operation of receiving from the AMF NE a response specifying that information about the sidelink connection is to be provided to the AMF NE. This advantageously enables LI monitoring of a target UE without requiring communications network nodes to be provided with information identifying target UEs.

In an embodiment, the response received from the AMF NE additionally specifies whether the target UE is allowed to connect to a UE-to-UE direct communication interface sidelink. The operations that the node is caused to perform further comprise the following operations. An operation of, if the target UE is allowed to connect to a UE-to-UE direct communication interface sidelink, informing the target UE and the at least one other UE of the UE-to-UE direct communication interface frequency to use for the sidelink connection. An operation of, if the target UE is not allowed to connect to a UE-to-UE direct communication interface sidelink, rejecting the sidelink connection request and sending a rejection message to the target UE containing a false reason why the sidelink connection cannot be created. This advantageously enables use of a UE-to-UE direct communication interface sidelink by a target UE to be prevented, if required by a relevant law enforcement agency, LEA, without alerting a user of the target UE that they are being prevented from using a sidelink connection.

In an embodiment, the operations that the node is caused to perform further comprise the following operation. In response to determining that the UE is a target UE, sending an information message to the AMF NE including an indication that the target UE has made a sidelink connection request and the identification of the at least one other UE involved in the sidelink connection. This advantageously enables the AMF NE to report the sidelink connection request to a relevant law enforcement management function, LEMF, and enables the node to identify the other UEs to send request messages to.

In an embodiment, the UE-to-UE direct communication interface is a PC5 reference point.

Corresponding embodiments and advantages also apply to the lawful interception, LI, system and to the method of LI in a communications network, described below.

A second aspect provides a communications network device hosting an access and mobility management function, AMF, network element, NE, the computing device comprising interface circuitry, at least one processor and memory comprising instructions which when performed by the at least one processor cause the communications network device to perform the following operations. An operation of receiving from a network node information messages containing information about a sidelink connection. An operation of sending intercept related information messages, xIRI, containing the information about the sidelink connection to a delivery function, DF, for forwarding to a law enforcement management function, LEMF.

The communications network device hosting an AMF NE enables LI monitoring of a target UE that is involved in a sidelink connection, in particular monitoring of information about the sidelink connection.

In an embodiment, the operations commence with the following operations. An operation of receiving from a lawful interception administration function, LI-ADMF, a request to receive notification of a target user equipment, UE, sending a request for permission to be involved in a sidelink connection. A target UE is a UE to be monitored for lawful interception, LI, purposes. An operation of receiving from the network node a permission request requesting permission for a UE to be involved in a sidelink connection. An operation of determining that the UE is a target UE. An operation of sending a response to the network node specifying that information about the sidelink connection is to be provided to the AMF NE. This advantageously enables LI monitoring of a target UE without requiring communications network nodes to be provided with information identifying target UEs.

In an embodiment, the response additionally specifies whether the target UE is allowed to connect to a UE-to-UE direct communication interface sidelink. This advantageously enables use of a UE-to-UE direct communication interface sidelink by a target UE to be prevented, if required by a relevant law enforcement agency, LEA.

In an embodiment, the operations further comprise the following operations. An operation of receiving an information message from the node including an indication that the target UE has made a sidelink connection request and the identification of at least one other UE involved in the sidelink connection. An operation of sending an xIRI to the DF including an indication that the target UE has made a sidelink connection request and the identification of the at least one other UE involved in the sidelink connection. This advantageously enables this information to be reported to a DF for forwarding to an LEMF.

In an embodiment, the operations further comprise receiving from the LI-ADMF information specifying whether information about the sidelink connection has to be provided to the AMF and whether communications data exchanged on the sidelink connection has to be provided to a user plane function, UPF. The operation of determining that the UE is a target UE comprises determining that information about the sidelink connection has to be provided to the AMF NE. This advantageously enables the AMF NE to determine that the UE is a target UE without requesting this information from another network element, thereby avoiding additional messaging within the communications network.

In an embodiment, the operations further comprise the following operations. An operation of comparing the information about the sidelink connection contained in the received information message with any other information about the sidelink connection previously received by the AMF NE. An operation of discarding any information about the sidelink connection that has been previously received by the AMF NE. An operation of sending to the DF an xIRI containing any information about the sidelink connection that has not been previously received by the AMF NE. This may reduce the amount of information to be sent and reduce the possibility of sending duplicate information to the DF or at the LEMF.

In an embodiment, the other information about the sidelink connection has been provided by another UE involved in the sidelink connection. This may reduce the amount of information to be sent and reduce the possibility of sending duplicate information to the DF or at the LEMF.

Corresponding embodiments and advantages also apply to the lawful interception, LI, system and to the method of LI in a communications network, described below.

A third aspect provides a communications network device hosting a user plane function, UPF, network element, NE, the communications network device comprising interface circuitry, at least one processor and memory comprising instructions which when performed by the at least one processor cause the communications network device to perform the following operations. An operation of receiving from a network node content messages including a copy of communications data exchanged on a sidelink connection. An operation of sending content of communication messages, xCC, to a delivery function, DF, for forwarding to a law enforcement management function, LEMF. The xCC include a copy of communications data exchanged on the sidelink connection received from the network node.

The communications network device hosting a UPF NE enables LI monitoring of a target UE that is involved in a sidelink connection, in particular monitoring of communications data exchanged on the sidelink connection.

In an embodiment, the operations further comprise the following operations. An operation of comparing the copy of communications data in the content message received from the network node with any other copy of communications data exchanged on the sidelink connection previously received by the UPF NE. An operation of discarding any copy of communications data exchanged on the sidelink connection that has been previously received by the UPF. An operation of sending an xCC to the DF containing any copy of communications data exchanged on the sidelink connection that has not been previously received by the UPF NE. This may reduce the amount of information to be sent and reduce the possibility of sending duplicate information to the DF or at the LEMF.

In an embodiment, the other copy of communications data exchanged on the sidelink has been provided to the network node by another UE involved in the sidelink. This may reduce the amount of information to be sent and reduce the possibility of sending duplicate information to the DF or at the LEMF.

Corresponding embodiments and advantages also apply to the lawful interception, LI, system and to the method of LI in a communications network, described below.

A fourth aspect provides a lawful interception, LI, system comprising a communications network node, communications network device hosting an access and mobility management function, AMF, network element, NE, and communications network device hosting a user plane function, UPF, network element, NE. The communications network node comprises interface circuitry, at least one processor and memory comprising instructions which when performed by the at least one processor cause the node to perform the following operations. An operation of receiving a sidelink connection request from a user equipment, UE. The sidelink connection request includes an identification of at least one other UE involved in the sidelink connection. An operation of determining that the UE is a target UE. A target UE is a UE to be monitored for lawful interception, LI, purposes. An operation of informing the target UE and the at least one other UE of a UE-to-UE direct communication interface frequency to use for the sidelink connection. An operation of sending a request message to the at least one other UE. A request message requests the at least one other UE to provide to the node information about the sidelink connection and data exchanged on the sidelink connection. An operation of sending to an access and mobility management function, AMF, an information message including information about the sidelink connection received from the at least one other UE. An operation of sending to a user plane function, UPF, content messages including communications data exchanged on the sidelink connection received from the at least one other UE. The communications network device hosting a AMF NE comprises interface circuitry, at least one processor and memory comprising instructions which when performed by the at least one processor cause the AMF NE to perform the following operations. An operation of receiving from a network node information messages containing information about a sidelink connection. An operation of sending intercept related information messages, xIRI, containing the information about the sidelink connection to a delivery function, DF, for forwarding to a law enforcement management function, LEMF. The communications network device hosting a UPF NE comprises interface circuitry, at least one processor and memory comprising instructions which when performed by the at least one processor cause the UPF NE to perform the following operations. An operation of receiving from a network node content messages including communications data exchanged on a sidelink connection. An operation of sending a content of communication message, xCC, to a delivery function, DF, for forwarding to a law enforcement management function, LEMF. The xCC include communications data exchanged on the sidelink connection received from the network node.

A fifth aspect provides communications network user equipment, UE, comprising interface circuitry, at least one processor and memory comprising instructions which when performed by the at least one processor cause the UE to perform the following operations. An operation of joining a sidelink connection using a UE-to-UE direct communication interface. An operation of receiving a request message from a communications network node. The request message requests the UE to provide to a communications network node information about the sidelink connection and a copy of communications data exchanged on the sidelink connection. An operation of sending to the communications network node information about the sidelink connection. An operation of sending to the communications network node a copy of communications data exchanged on the sidelink connection.

The UE enables LI monitoring of a target UE that is involved in a sidelink connection, including monitoring of information about the sidelink connection and monitoring of communications data exchanged on the sidelink connection.

In an embodiment, the operations further comprise the following operations. An operation of determining whether the UE is connected to a communications network node. An operation of, if the UE is connected to a communications network node, while the sidelink connection is ongoing, sending to the communications network node information about the sidelink connection and a copy of communications data exchanged on the sidelink connection. Operations of, if the UE is not connected to a communications network node, while the sidelink connection is ongoing, storing information about the sidelink connection and a copy of communications data exchanged on the sidelink connection, and when the UE becomes connected to a communications network node, sending to the communications network node at least the stored information about the sidelink connection. The UE advantageously enables LI monitoring to be performed whether or not the UE is currently connected to a communications node.

In an embodiment, the operations further comprise, when the UE becomes connected to a communications network node, also sending to the communications network node the stored copy of communications data exchanged on the sidelink connection. The UE advantageously enables LI interception of exchanged data to be performed whether or not the UE is currently connected to a communications node.

In an embodiment, the UE-to-UE direct communication interface is a PC5 reference point.

In an embodiment, the operations further comprise connecting to a communications network node using an air interface, and wherein the information about the sidelink connection is sent to the communications network node over the air interface. The UE advantageously sends the information to the communications network node over a separate interface to the sidelink connection.

In an embodiment, the copy of communications data exchanged on the sidelink connection is also sent to the communications network node over the air interface. The UE advantageously sends the exchanged data to the communications network node over a separate interface to the sidelink connection.

In an embodiment, the air interface is a Uu reference point.

In an embodiment, the UE is a target UE. Information about the sidelink connection and a copy of the communications data exchanged on the sidelink connection can advantageously be provided directly from the target UE.

In an embodiment, the UE is not a target UE and is involved in a sidelink connection with a target UE. Using another UE to acquire the information about the sidelink connection and the exchanged data advantageously enable LI monitoring of a target UE without any risk of the target UE noticing that extra information is being sent from it and mitigates the risk of a target UE blocking the information and exchanged data from being transmitted to a communications network node.

Corresponding embodiments and advantages also apply to the method of LI at a UE described below.

A sixth aspect provides a method of lawful interception, LI, in a communications network. The method includes steps at a communications network node, steps at an access and mobility management function, AMF, network element, NE, and steps at a user plane function, UPF, NE. The steps at a communications network node include the following. A sidelink connection request is received from a user equipment, UE. The sidelink connection request includes an identification of at least one other UE involved in the sidelink connection. It is determined that the UE is a target UE, wherein a target UE is a UE to be monitored for lawful interception, LI, purposes. The target UE and the at least one other UE are informed of a UE-to-UE direct communication interface frequency to use for the sidelink connection. A request message is sent to the at least one other UE. The request message requests the at least one other UE to provide to the node information about the sidelink connection and a copy of communications data exchanged on the sidelink connection. An information message is sent to an access and mobility management function, AMF. The information message includes information about the sidelink connection received from the at least one other UE. Content messages are sent to a user plane function, UPF. The content messages include a copy of communications data exchanged on the sidelink connection received from the at least one other UE. The steps at an AMF NE include the following. The information messages are received from the network node; the information messages contain the information about the sidelink connection. Intercept related information messages, xIRI, containing the information about the sidelink connection are sent to a delivery function, DF, for forwarding to a law enforcement management function, LEMF. The steps at a UPF NE include the following. Content messages are received from the network node; the content messages include a copy of communications data exchanged on a sidelink connection. Content of communication messages, xCC, are sent to a delivery function, DF, for forwarding to a law enforcement management function, LEMF. The xCC include a copy of communications data exchanged on the sidelink connection received from the network node.

A seventh aspect provides a method of lawful interception, LI, at a user equipment, UE. The method includes the following steps. The UE joins a sidelink connection using a UE-to-UE direct communication interface. The UE receives a request message from a communications network node. The request message requests the UE to provide to the node information about the sidelink connection and a copy of communications data exchanged on the sidelink connection. The UE sends information about the sidelink connection to the communications network node. The UE sends a copy of communications data exchanged on the sidelink connection to the communications network node.

An eighth aspect provides a computer program comprising instructions which, when executed on at least one processor, cause the at least one processor to carry out any of the steps of the above method of lawful interception, LI, in a communications network.

A ninth aspect provides a computer program comprising instructions which, when executed on at least one processor, cause the at least one processor to carry out any of the steps of the above method of lawful interception, LI, at a user equipment.

Embodiments of the invention will now be described, by way of example only, with reference to the accompanying drawings.

### BRIEF DESCRIPTION OF THE DRAWINGS

FIG. 1 is a block diagram illustrating an embodiment of a network node;

FIG. 2 is a block diagram illustrating an embodiment of a communications network device hosting an access and mobility management function, AMF, network element, NE;

FIG. 3 is a block diagram illustrating an embodiment of a communications network device hosting a user plane function, UPF, network element, NE;

FIG. 4 is a flowchart illustrating operation of a network node according to an embodiment of a method;

FIG. 5 is a flowchart illustrating operation of a network node, an AMF NE and a UPF NE according to embodiments of methods;

FIG. 6 is a block diagram illustrating an embodiment of a user equipment, UE;

FIGS. 7 and 8 are flowchart illustrations of operation of a user equipment according to an embodiment;

FIGS. 9 and 10 are block diagrams illustrating embodiments of a lawful interception system;

FIGS. 11 and 12 are signalling diagrams illustrating exchanges of signals in an embodiment of a lawful interception system; and

FIGS. 13 to 16 are flowcharts illustrating embodiments of method steps.

### DETAILED DESCRIPTION

The same reference numbers are for corresponding features in different embodiments.

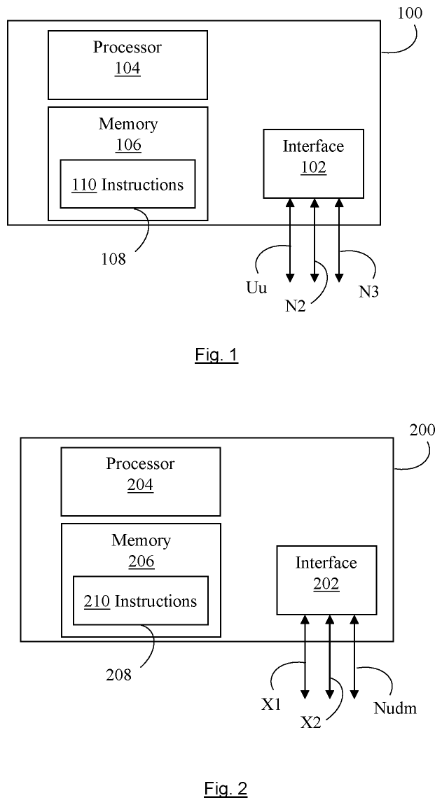

Referring to FIG. 1, an embodiment provides a communications network node 100 comprising interface circuitry 102, a processor 104 and memory 106. The memory comprises instructions 110 which when performed by the processor cause the node to perform operations as follows.

The node 100 receives a sidelink connection request from a user equipment, UE. The sidelink connection request includes an identification of at least one other UE involved in the sidelink connection. A sidelink connection may involve two UEs or may involve a greater number of UEs. As the skilled person will know, sidelink connections support three communication modes: unicast mode, groupcast mode and broadcast mode. These are defined in relation to, for example the PC5 reference point, at section 5.2.1 of 3GPP standard TS 23.287 V16.5.0 (December 2020).

The node determines that the UE is a target UE; a target UE is a UE that is to be monitored for lawful interception, LI, purposes. The node informs the target UE and the at least one other UE of a UE-to-UE direct communication interface frequency to use for the sidelink connection.

The node sends a request message to the at least one other UE. The request message requests the other UE to provide information about the sidelink connection to the node and a copy of communications data exchanged on the sidelink connection to the node. The node sends an information message to an access and mobility management function, AMF, network element, NE (also referred to herein as ‘AMF’). The information message includes information about the sidelink connection received from the at least one other UE. The node sends content messages to a user plane function, UPF, network element, NE, (also referred to herein as ‘UPF’). The content messages include a copy of communications data exchanged on the sidelink connection received from the at least one other UE.

In an embodiment, the node 100 is caused to determine that the UE is a target UE by sending a permission request to the AMF, the permission request requesting permission for the UE to be involved in a sidelink connection, and receiving a response from the AMF, the response specifying that information about the sidelink connection is to be provided to the AMF.

In an embodiment, the AMF response additionally specifies whether the target UE is allowed to connect to a UE-to-UE direct communication interface sidelink. The node 100 is caused to, if the target UE is allowed to connect to a UE-to-UE direct communication interface sidelink, inform the target UE and the at least one other UE of the UE-to-UE direct communication interface frequency to use for the sidelink connection. The node is caused to, if the target UE is not allowed to connect to a UE-to-UE direct communication interface sidelink, reject the sidelink connection request and send a rejection message to the target UE containing a false reason why the sidelink connection cannot be created.

In an embodiment, the node 100 is caused to, in response to determining that the UE is a target UE, send an information message to the AMF. The information message includes an indication that the target UE has made a sidelink connection request and the identification of the at least one other UE involved in the sidelink connection.

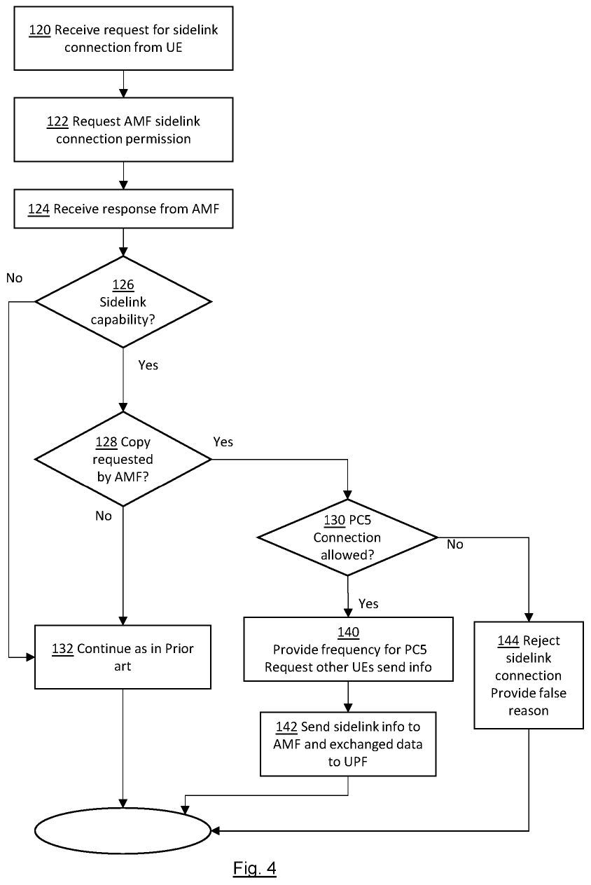

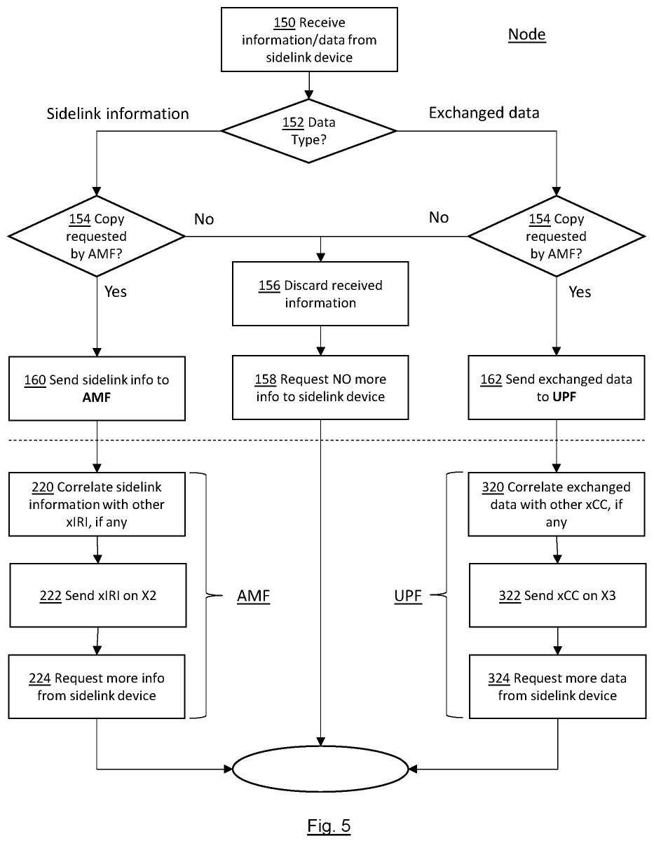

In an embodiment, the node 100 is caused to perform the operations illustrated in FIGS. 4 and 5. Referring to FIG. 4, the node 100 receives 120 a sidelink connection request from a UE. The sidelink connection request includes an identification of other UEs involved in the sidelink connection. The node sends 122 a permission request to the AMF, requesting permission for the UE to be involved in a sidelink connection. The node receives 124 a response from the AMF, the response includes information about the sidelink capability of the UE and whether information about the sidelink connection is to be provided to the AMF.

The node checks 126 the information provided in the response to determined whether the UE has sidelink capability. If the UE does not have sidelink capability the UE cannot take part in a sidelink connection, so the UE can only continue 132 to communicate on an air interface.

If the UE does have sidelink capability, the node then checks 128 the AMF response to determine whether information about the sidelink connection and a copy of communications data exchanged on the sidelink connection is to be provided to the AMF. If the AMF does not require information about the sidelink connection or a copy of communications data exchanged on the sidelink connection, the node continues 132 to create a sidelink connection in accordance with, for example, the V2X standard TS 23.287 V16.5.0 (December 2020).

If the AMF does require information about the sidelink connection and/or a copy of communications data exchanged on the sidelink connection, the node checks 130 whether the UE is allowed to connect to a sidelink, for example a V2X PC5 sidelink; the LEA may require, in the warrant that it has issued, that the UE is not to be permitted to connect to any sidelink.

If the UE is not allowed to connect to a sidelink, the node rejects 144 the UE's sidelink connection request and provides a false reason, for example “the network is unavailable”, to the UE, so that the UE/a user of the UE is not alerted to the fact that the sidelink connection request has been rejected.

If the UE is allowed to connect to a sidelink, the node informs 140 the UE, and at least one other UE involved in the sidelink, of the UE-to-UE direct communication interface, for example PC5, frequency to use for the sidelink connection. The node also sends 140 a request message to at least one other UE involved in the sidelink, requesting the at least one other UE to provide information about the sidelink connection and a copy of communications data exchanged on the sidelink connection to the node.

The node receives information about the sidelink connection, as described above, and sends 142 an information message to the AMF; the information message contains the information about the sidelink connection. The node also sends 142 content messages to the UPF; the content messages contain the copy of communications data exchanged on the sidelink connection. This is described in more detail in FIG. 5.

When the node receives 150 information/data from a UE involved in a sidelink the node first checks 152 the data type to determine whether it has received sidelink connection information or a copy of communications data exchanged on the sidelink connection. The node then checks 154 whether the AMF has requested the node to provide information about the sidelink connection or to provide a copy of communications data exchanged on the sidelink connection. If the AMF has not made such a request, the received information/data is discarded 156 and the node sends 158 a request to the sidelink UE not to send any more information about the sidelink connection.

If the AMF has requested the node to provide information about the sidelink connection, the node then sends 160 an information message to the AMF containing the received information. If the AMF has requested the node to provide a copy of communications data exchanged on the sidelink connection, the node then sends 162 a content message to the UPF containing the received data.

Referring to FIG. 2, an embodiment provides a communications network device 200 hosting an access and mobility management function, AMF, network element, NE. The communications network device comprises interface circuitry 202, a processor 204 and memory 206. The memory comprises instructions 110 which when performed by the processor cause the AMF NE (also referred to herein as ‘AMF’) to perform operations as follows.

The AMF receives information messages from a network node. The information messages contain information about a sidelink connection. The AMF sends intercept related information messages, xIRI, containing the information about the sidelink connection to a delivery function, DF, for forwarding to a law enforcement management function, LEMF.

In an embodiment, the AMF is caused to perform the following operations prior to receiving information messages from a network node. The AMF receives a request, from a lawful interception administration function, LI-ADMF, to receive notification of a target user equipment, UE. A target UE is a UE to be monitored for lawful interception, LI, purposes.

The AMF receives a permission request from the network node; the permission request requests permission for a UE to be involved in a sidelink connection. The AMF determines that the UE is a target UE and sends a response to the network node specifying that information about the sidelink connection is to be provided to the AMF.

In an embodiment, the response sent by the AMF to the network node additionally specifies whether the target UE is allowed to connect to a UE-to-UE direct communication interface sidelink.

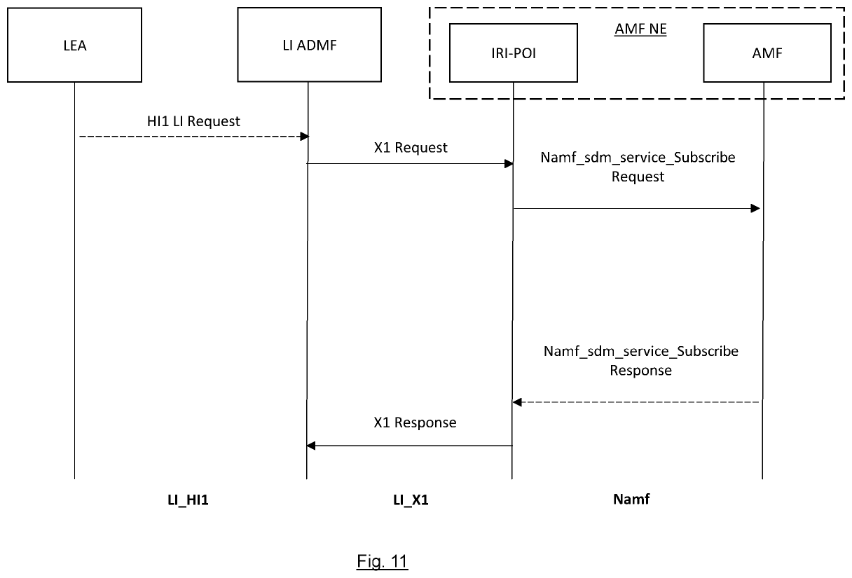

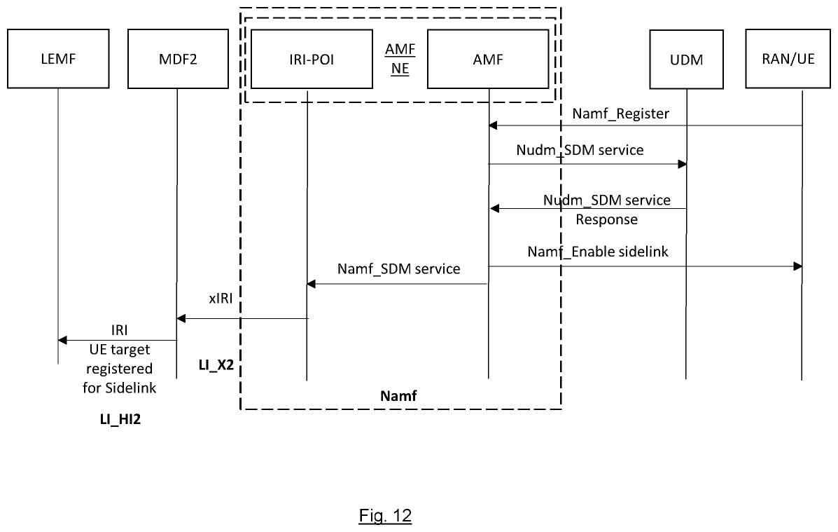

FIGS. 11 and 12 are signalling diagrams illustrating operations performed by the AMF in an embodiment.

A law enforcement agency, LEA, sends an LI Request to the LI-ADMF on the HI1 interface. The LI-ADMF sends a Request to the AMF NE on the X1 interface to receive notifications from the AMF of UEs that are enabled to perform sidelink communications. The AMF NE includes an intercept related information, IRI, point of interception, POI. The IRI POI receives the X1 Request and sends a service subscription request (Namf_sdm_service_Subscribe Request) to the AMF. The AMF subscribes the LI ADMF to the requested notifications and sends a service subscription response (Namf_sdm_service_Subscribe Response) back to the IRI-POI, which sends a Response on X1 back to the LI ADMF confirming subscription to notifications.

After a successful subscription of the LI-ADMF to notifications from the AMF, when a UE sends request to be registered to a sidelink connection (Namf_Register), the AMF sends a request for information about the UE (Nudm_SDM service) to a unified data management, UDM, function. The UDM sends a service response (Nudm_SDM service Response) including the requested information. The AMF sends a message to the communications network node (RAN) about the possibility of the UE to use the sidelink connection (Namf_Enable sidelink). The message specifies whether information about the sidelink connection has to be provided to the AMF, whether a copy of communications data exchanged on the sidelink connection has to be provided to the UPF, and whether or not the UE is permitted to use a PC5 sidelink connection.

The AMF also sends the information that the UE has registered for a sidelink connection to the IRI-POI (Namf_SDM service) and sends an xIRI to a mediation and delivery function, MDF2, on the X2 interface, containing information that a target UE is registered for the sidelink connection. The MDF2 sends an IRI to the LEMF including the information that a target UE is registered for a sidelink connection.

In an embodiment, the AMF NE is additionally caused to perform the following operations. The AMF receives an information message from the node. The information message includes an indication that the target UE has made a sidelink connection request and the identification of at least one other UE involved in the sidelink connection. The AMF sends an xIRI to the DF. The xIRI includes an indication that the target UE has made a sidelink connection request and the identification of the at least one other UE involved in the sidelink connection.

In an embodiment, the AMF NE is additionally caused to perform the following operations. The AMF receives information from the LI-ADMF. The information specifies whether information about the sidelink connection has to be provided to the AMF and whether communications data exchanged on the sidelink connection has to be provided to a user plane function, UPF. The AMF determines that the UE is a target UE by determining that the information received from the LI-ADMF specifies that information about the sidelink connection has to be provided to the AMF.

In an embodiment, the AMF NE is additionally caused to perform the following operations. The AMF compares the information about the sidelink connection contained in the received information message with any other information about the sidelink connection previously received by the AMF. Any information about the sidelink connection that has been previously received by the AMF is discarded. The AMF sends an xIRI to the DF; the xIRI contains any information about the sidelink connection that has not been previously received by the AMF.

In an embodiment, the other information about the sidelink connection has been provided by another UE involved in the sidelink connection. The other UE is not a target UE.

In an embodiment, the AMF NE is caused to perform the operations illustrated in FIG. 5. The AMF receives an information message from a network node. The information message contains information about the sidelink connection received by the network node, as described above. The AMF correlates 220 the information about the sidelink connection contained in the received information message with any other information about the sidelink connection previously received by the AMF. Any information about the sidelink connection that has been previously received by the AMF is discarded.

The AMF sends 222 an xIRI to the DF on an LI X2 interface; the xIRI contains any information about the sidelink connection that has not been previously received by the AMF.

The AMF sends 224 a request to the node to request more information from the other UE involved in the sidelink.

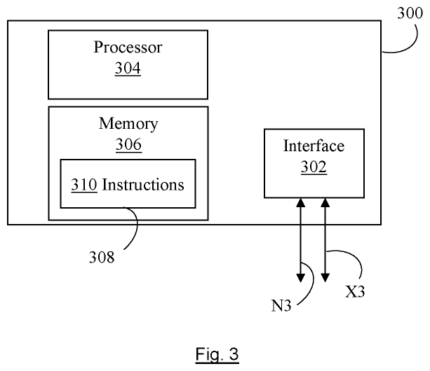

Referring to FIG. 3, an embodiment provides a communications network device 300 hosting a user plane function, UPF, network element, NE. The communications network device comprises interface circuitry 302, a processor 304 and memory 306. The memory comprises instructions 310 which when performed by the processor cause the UPF NE (also referred to herein as ‘UPF’) to perform operations as follows.

The UPF receives content messages from a network node. The content messages include a copy of communications data exchanged on a sidelink connection. The UPF sends a content of communication message, xCC, to a delivery function, DF, for forwarding to a law enforcement management function, LEMF. The xCC includes a copy of communications data exchanged on the sidelink connection received from the network node.

In an embodiment, the UPF NE is additionally caused to perform the following operations. The UPF compares the copy of communications data in the content message received from the network node with any other copy of communications data exchanged on the sidelink connection that has been previously received by the UPF. The UPF discards any copy of communications data exchanged on the sidelink connection that has been previously received by the UPF. The UPF sends an xCC to the DF containing any copy of communications data exchanged on the sidelink connection that has not been previously received by the UPF.

In an embodiment, the other copy of communications data exchanged on the sidelink has been provided to the network node by another UE involved in the sidelink.

In an embodiment, the UPF NE 300 is caused to perform the operations illustrated in FIG. 5. The UPF receives content messages from a network node. The content messages include a copy of communications data exchanged on a sidelink connection, as described above.

The UPF correlates 320 the copy of communications data exchanged on the sidelink connection with any other copy of communications data exchanged on the sidelink connection that has previously been received by the UPF. The UPF discards any copy of communications data exchanged on the sidelink connection that has previously been received by the UPF. The UPF sends 322 an xCC to the DF on an LI X3 interface, for forwarding to a law enforcement management function, LEMF. The xCC contains any copy of communications data exchanged on the sidelink connection that has not been previously received by the UPF.

The UPF sends 324 a request to the node to request UEs involved in the sidelink connection to continue sending a copy of communications data exchanged on the sidelink connection.

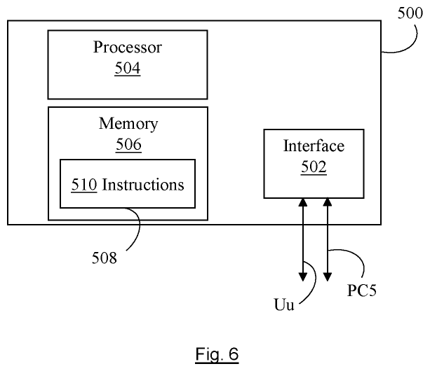

Referring to FIG. 6, an embodiment provides a communications network user equipment, UE, 500 comprising interface circuitry 502, a processor 504 and memory 506. The memory comprises instructions 510 which when performed by the processor cause the UE to perform the following operations.

The UE is operable to join a sidelink connection using a UE-to-UE direct communication interface. The UE receives a request message from a communications network node. The request message requests the UE to provide information about the sidelink connection and to provide a copy of communications data exchanged on the sidelink connection. The UE is operable to send information about the sidelink connection to a communications network node, which may be the same node that the UE received the request message from or may be a different node. The UE is also operable to send a copy of communications data exchanged on the sidelink connection to a communications network node, which may be the same node that the UE received the request message from or may be a different node.

In an embodiment, the UE 500 is additionally caused to perform the following operations. The UE is operable to determine whether it is connected to a communications network node.

The UE is operable to, if it is connected to a communications network node, and while the sidelink connection is ongoing, send to the node information about the sidelink connection and a copy of communications data exchanged on the sidelink connection.

The UE is operable to, if it is not connected to a communications network node, and while the sidelink connection is ongoing, store information about the sidelink connection and a copy of communications data exchanged on the sidelink connection. When the UE subsequently becomes connected to a communications network node after a period of not being connected, the UE sends the stored information about the sidelink connection to the communications network node.

In an embodiment, the UE is operable to, when it becomes connected to a communications network node after a period of not being connected, also send the stored copy of communications data exchanged on the sidelink connection to the communications network node.

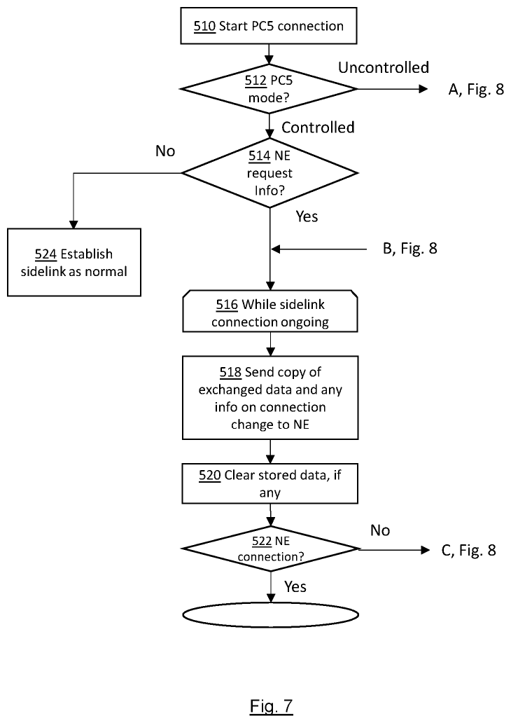

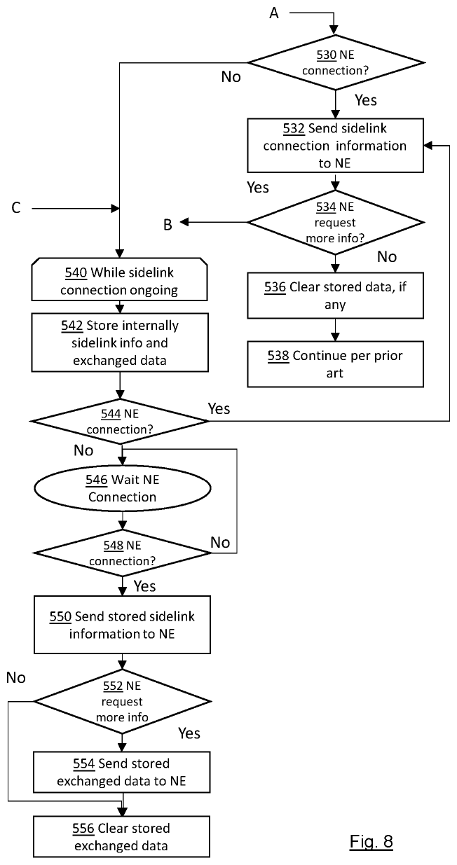

In an embodiment, the UE 500 is caused to perform the operations illustrated in FIGS. 7 and 8.

The UE joins 510 a PC5 sidelink connection and determines whether the PC5 sidelink is operating in a controlled mode (in which the UE requests the PC5 frequency to use for the sidelink from a communications network node) or in an uncontrolled mode (in which the UE selects the PC5 frequency itself, without reference to a communications network node). In a controlled PC5 mode UEs are sure that other UEs are not using the same PC5 frequency but a connection to a node is required to obtain the frequency. In an uncontrolled PC5 mode it is possible that UEs from different sidelink connections are using the same PC5 frequency but no connection to a node is required to establish the sidelink connection.

### Controlled Mode

If the PC5 sidelink is to operate in controlled mode, the UE checks 514 whether it has been requested to provide information about the sidelink to a communications network node. If it has not, the UE proceeds with establishing 524 the PC5 sidelink as normal.

If the UE has been requested to provide information about the sidelink, then, while 516 the sidelink connection is ongoing and while 522 the UE is connected to a communications network node, the UE sends 518 information about the sidelink connection and a copy of communications data exchanged on the sidelink connection to the communications network node. Any stored data is cleared 520.

If the UE is not connected to a communications network node 522, then, while 540 the sidelink is ongoing, the UE internally stores 542 information about the sidelink connection and a copy of communications data exchanged on the sidelink connection. If the UE becomes connected 544 to a communications network node, the UE sends 532 the stored information about the sidelink connection to the node.

The UE checks whether is has been requested 534 to provide more information. If it has not, the UE clears 536 the stored information and data, and returns to normal operation 538. If the UE has been requested 534 to provide more information, the UE proceeds to operation 516.

When the sidelink connection terminates, if the UE is not connected to a communications network node 544, the UE proceeds to wait 546, 548 for a connection. No more data are stored and the UE waits for a connection to send the previously stored data to the node. Once the UE has a connection to a communications network node, the UE sends 550 the previously stored information about the sidelink connection and checks 552 whether it has been requested to also provide a copy of communications data exchanged on the sidelink connection. If it has, the UE sends 554 the copy of communications data exchanged on the sidelink connection to the node and clears 556 the stored copy of communications data.

### Uncontrolled Mode

If the PC5 sidelink is to operate in uncontrolled mode, the UE checks 530 whether it has a connection to a communications network node. If it does not, the UE proceeds to operation 540. If the UE has a connection to a communications network node, the UE sends 532 information about the sidelink connection to the node and checks 534 whether it has been requested to provide more information. If it has not, the UE clears 536 the stored information and data, and returns to normal operation 538. If the UE has been requested 534 to provide more information, the UE proceeds to operation 516.

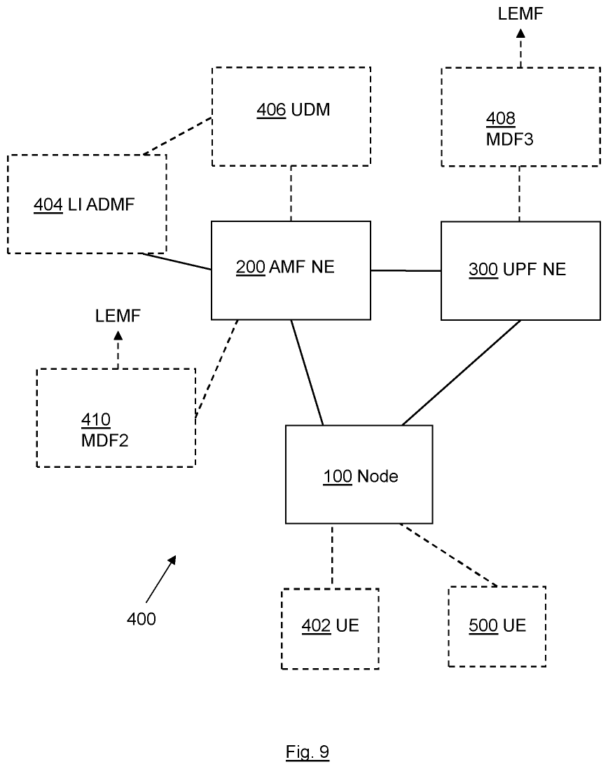

Referring to FIG. 9, an embodiment provides a lawful interception, LI, system 400 comprising a communications network node 100 as described above with reference to FIG. 1, an AMF NE 200 as described above with reference to FIG. 2 and UPF NE 300 as described above with reference to FIG. 3.

The node 100 receives a sidelink connection request from a user equipment, UE 402. The sidelink connection request includes an identification of another UE 500 involved in the sidelink connection, as described with reference to FIG. 6.

The node determines that the UE 402 is a target UE. The node informs the target UE 402 and the other UE 500 of a UE-to-UE direct communication interface frequency to use for the sidelink connection.

The node sends a request message to the other UE 500. The request message requests the other UE to provide information about the sidelink connection to the node and a copy of communications data exchanged on the sidelink connection to the node. The node sends an information message to the AMF 200. The information message includes information about the sidelink connection received from the other UE. The node sends content messages to the UPF 300. The content messages include a copy of communications data exchanged on the sidelink connection received from the other UE.

The AMF 200 receives information messages from the node 100. The information messages contain information about the sidelink connection involving the UE 402 and the other UE 500. The AMF sends xIRI containing the information about the sidelink connection to a management and delivery function, MDF2 410, for forwarding to a law enforcement management function, LEMF.

The UPF 300 receives content messages from the node 100. The content messages include a copy of communications data exchanged on the sidelink connection between the UEs 402, 500. The UPF sends an xCC to a management and delivery function, MDF3, 408 for forwarding to the LEMF. The xCC includes a copy of communications data exchanged on the sidelink connection received from the node.

In an embodiment, the AMF 200 receives a request from an LI-ADMF 404 to receive notification of a target user equipment, UE; the UE 402.

The AMF receives a permission request from the node 100; the permission request requests permission for the UE 402 to be involved in a sidelink connection with the other UE 500. The AMF determines that the UE 402 is a target UE and sends a response to the network node specifying that information about the sidelink connection between the UE 402 and the other UE 500 is to be provided to the AMF.

The LI-ADMF 404 obtains information about the UE 402 from a unified data management, UDM, function 406, the information including whether the UE 402 has sidelink capability.

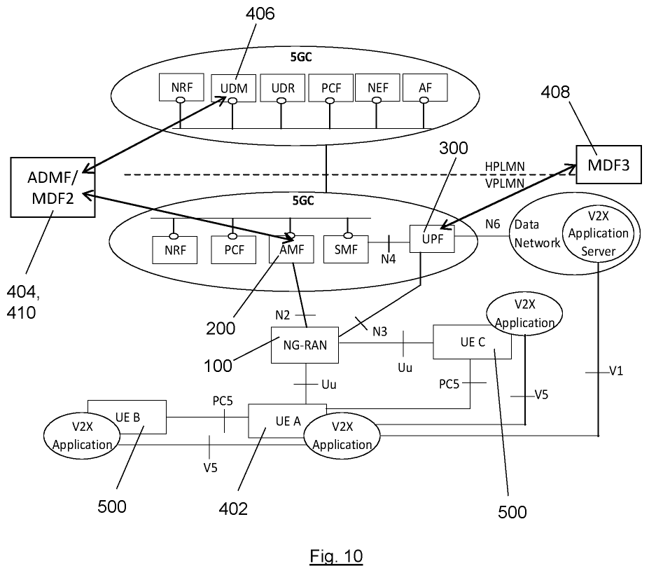

FIG. 10 illustrates the LI system 400 implemented within a 5G communications network. The communications network node 100 is a next generation radio access network, NG-RAN, evolved node B, eNB. The UE-to-UE direct communication interface is a V2X PC5 interface. The UEs 402, 500 communicate with the node 100 over a Uu air interface. The 5G network core, 5GC, is formed of a home public land mobile network, HPLMN, and a visited public land mobile network, VPLMN. The HPLMN comprises a network repository function, NRF, the UDM 406, a unified data repository, UDR, a policy and charging function, PCF, a network exposure function, NEF, and an application function, AF. The VPLMN comprises an NRF, a PCF, the AMF 200, a session management function, SMF, and the UPF 300. The construction and operation of a 5G communications network will be well known to the skilled person and is described in the relevant technical standards, which the skilled person will be aware of, so it will not be described in detail here.

Corresponding embodiments apply also to the methods of LI described below.

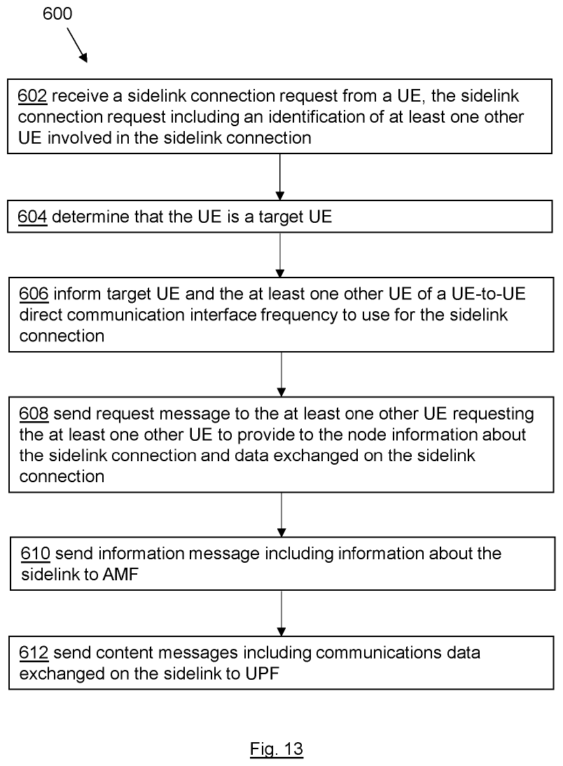

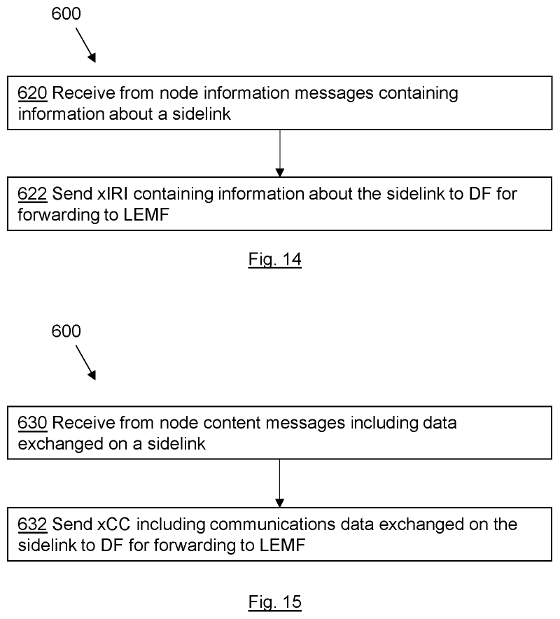

Referring to FIGS. 13 to 15, an embodiment provides a method of LI in a communications network. The method includes steps performed at a communications network node, steps performed at an access and mobility management function, AMF, network element, NE, (also referred to herein as ‘AMF’) and steps performed at a user plane function, UPF, network element, NE (also referred to herein as ‘UPF’).

The steps of the method, at the communications network node, include the following. A sidelink connection request is received 602 from a user equipment, UE. The sidelink connection request includes an identification of at least one other UE involved in the sidelink connection. It is determined 604 that the UE is a target UE; a target UE is a UE to be monitored for LI purposes. The target UE and the at least one other UE are informed 606 of a UE-to-UE direct communication interface frequency to use for the sidelink connection. A request message is sent 608 to the at least one other UE. The request message requests the at least one other UE to provide to the node information about the sidelink connection and a copy of communications data exchanged on the sidelink connection. An information message is sent 610 to an access and mobility management function, AMF. The information message includes information received from the at least one other UE about the sidelink connection. Content messages are sent 612 to a user plane function, UPF. The content messages include a copy of communications data exchanged on the sidelink connection received from the at least one other UE.

The steps of the method at the AMF NE include the following. The AMF NE receives 620 information messages from the network node. The information messages contain information about the sidelink connection. Intercept related information messages, xIRI, are sent by the AMF NE to a delivery function, DF, for forwarding to a law enforcement management function, LEMF. The xIRI contain the information about the sidelink connection received from the network node.

The steps of the method at the UPF NE include the following. The UPF NE receives 630 content messages from the network node. The content messages include a copy of communications data exchanged on the sidelink connection. The UPF NE sends content of communication message, xCC, to a delivery function, DF, for forwarding to a law enforcement management function, LEMF. The xCC include a copy of communications data exchanged on the sidelink connection received from the network node.

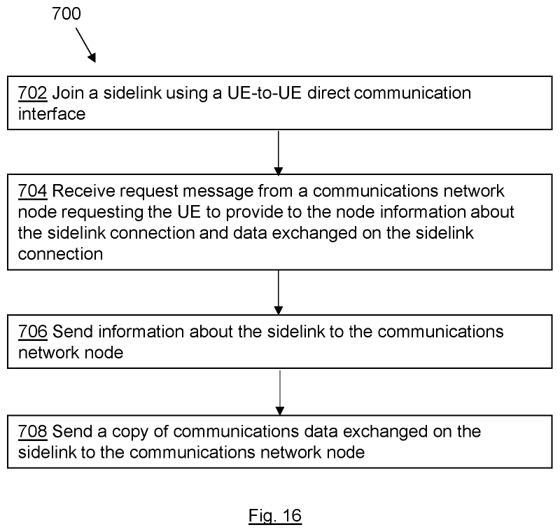

Referring to FIG. 16, an embodiment provides a method 700 of LI at a UE. The method includes the following steps.

The UE joins 702 a sidelink connection using a UE-to-UE direct communication interface. The UE receives 704 a request message from a communications network node (“node”). The request message requests the UE to provide information about the sidelink connection and a copy of communications data exchanged on the sidelink connection to the node. The UE sends 706 information about the sidelink connection to the node. The UE sends 708 a copy of communications data exchanged on the sidelink connection to the node.

In an embodiment, the UE is an LI target UE. This enables LI information and data to flow from the target UE itself.

In an embodiment, the UE is involved in a sidelink with a target UE but the UE is not itself a target UE. This avoids the risk that a user of a target UE notices that extra information is being sent from it's sidelink or is being sent from the target UE to a communications network node.

An embodiment provides a computer program 108, 208, 308 comprising instructions which, when executed on at least one processor, cause the at least one processor to carry out steps of the above method of LI in a communications network.

An embodiment provides a computer program 508 comprising instructions which, when executed on at least one processor of a UE, cause the at least one processor to carry out the steps of the above method of LI at a UE.

1-21. (canceled)

22. A communications network node comprising interface circuitry, at least one processor and memory comprising instructions which when performed by the at least one processor cause the node to perform operations of:
receiving a sidelink connection request from a user equipment (UE), the sidelink connection request including an identification of at least one other UE involved in the sidelink connection;
determining that the UE is a target UE, wherein a target UE is a UE to be monitored for lawful interception (LI) purposes;
informing the target UE and the at least one other UE of a UE-to-UE direct communication interface frequency to use for the sidelink connection;
sending a request message to the at least one other UE, the request message requesting the at least one other UE to provide to the node information about the sidelink connection and a copy of communications data exchanged on the sidelink connection;
sending to an access and mobility management function (AMF) network element (NE) an information message including information about the sidelink connection received from the at least one other UE; and
sending to a user plane function, UPF, network element (NE) content messages including a copy of communications data exchanged on the sidelink connection received from the at least one other UE.

23. The communications network node of claim 22, wherein the operation of determining that the UE is a target UE comprises:
sending to the AMF NE a permission request requesting permission for the UE to be involved in a sidelink connection; and
receiving from the AMF NE a response specifying that information about the sidelink connection is to be provided to the AMF NE.

24. The communications network node of claim 23, wherein
the response additionally specifies whether the target UE is allowed to connect to a UE-to-UE direct communication interface sidelink, and
the operations further comprise:
if allowed, informing the target UE and the at least one other UE of the UE-to-UE direct communication interface frequency to use for the sidelink connection; and
if not allowed, rejecting the sidelink connection request and sending a rejection message to the target UE containing a false reason why the sidelink connection cannot be created.

25. The communications network node of claim 22, wherein the operations further include, in response to determining that the UE is a target UE, sending an information message to the AMF NE including an indication that the target UE has made a sidelink connection request and the identification of the at least one other UE involved in the sidelink connection.

26. A communications network device hosting an access and mobility management function (AMF) network element (NE) the communications network device comprising interface circuitry, at least one processor and memory comprising instructions which when performed by the at least one processor cause the communications network device to perform operations of:
receiving from a network node information messages containing information about a sidelink connection; and
sending intercept related information messages (xIRI) containing the information about the sidelink connection to a delivery function (DF) for forwarding to a law enforcement management function (LEMF).

27. The communications network device of claim 26, wherein the operations commence with operations of:
receiving from a lawful interception administration function (LI-ADMF) a request to receive notification of a target user equipment (UE) sending a request for permission to be involved in a sidelink connection, wherein a target UE is a UE to be monitored for lawful interception (LI) purposes;
receiving from the network node a permission request requesting permission for a UE to be involved in a sidelink connection;
determining that the UE is a target UE; and
sending a response to the network node specifying that information about the sidelink connection is to be provided to the AMF NE.

28. The communications network device of claim 27, wherein the response additionally specifies whether the target UE is allowed to connect to a UE-to-UE direct communication interface sidelink.

29. The communications network device of claim 27, wherein the operations further comprise:
receiving an information message from the node including an indication that the target UE has made a sidelink connection request and the identification of at least one other UE involved in the sidelink connection; and
sending an xIRI to the DF including an indication that the target UE has made a sidelink connection request and the identification of the at least one other UE involved in the sidelink connection.

30. The communications network device of claim 28, wherein the operations further comprise:
receiving an information message from the node including an indication that the target UE has made a sidelink connection request and the identification of at least one other UE involved in the sidelink connection; and
sending an xIRI to the DF including an indication that the target UE has made a sidelink connection request and the identification of the at least one other UE involved in the sidelink connection.

31. The communications network device of claim 27, wherein the operations further comprise receiving from the LI-ADMF information specifying:
whether information about the sidelink connection has to be provided to the AMF NE; and
whether communications data exchanged on the sidelink connection has to be provided to a user plane function, UPF NE;
and wherein the operation of determining that the UE is a target UE comprises determining that information about the sidelink connection has to be provided to the AMF NE.

32. The communications network device of claim 28, wherein the operations further comprise receiving from the LI-ADMF information specifying:
whether information about the sidelink connection has to be provided to the AMF NE; and
whether communications data exchanged on the sidelink connection has to be provided to a user plane function, UPF NE;
and wherein the operation of determining that the UE is a target UE comprises determining that information about the sidelink connection has to be provided to the AMF NE.

33. The communications network device of claim 26, wherein the operations further comprise:
comparing the information about the sidelink connection contained in the received information message with any other information about the sidelink connection previously received by the AMF NE;
discarding any information about the sidelink connection that has been previously received by the AMF NE; and
sending to the DF an xIRI containing any information about the sidelink connection that has not been previously received by the AMF NE.

34. The communications network device of claim 27, wherein the operations further comprise:
comparing the information about the sidelink connection contained in the received information message with any other information about the sidelink connection previously received by the AMF NE;
discarding any information about the sidelink connection that has been previously received by the AMF NE; and
sending to the DF an xIRI containing any information about the sidelink connection that has not been previously received by the AMF NE.

35. The communications network device of claim 28, wherein the operations further comprise:
comparing the information about the sidelink connection contained in the received information message with any other information about the sidelink connection previously received by the AMF NE;
discarding any information about the sidelink connection that has been previously received by the AMF NE; and
sending to the DF an xIRI containing any information about the sidelink connection that has not been previously received by the AMF NE.

36. The communications network device of claim 33, wherein the other information about the sidelink connection has been provided by another UE involved in the sidelink connection.

37. The communications network device of claim 34, wherein the other information about the sidelink connection has been provided by another UE involved in the sidelink connection.

38. A communications network device hosting a user plane function (UPF) network element (NE) the communications network device comprising interface circuitry, at least one processor and memory comprising instructions which when performed by the at least one processor cause the communications network device to perform operations of:
receiving from a network node content messages including a copy of communications data exchanged on a sidelink connection;
comparing the copy of communications data in the content message received from the network node with any other copy of communications data exchanged on the sidelink connection previously received by the UPF NE;
discarding any copy of communications data exchanged on the sidelink connection that has been previously received by the UPF NE; and
sending content of communication messages (xCC) to a delivery function (DF) for forwarding to a law enforcement management function (LEMF), the XCC containing any copy of communications data exchanged on the sidelink connection received from the network node that has not been previously received by the UPF NE.

39. The communications network device of claim 38, wherein the other copy of communications data exchanged on the sidelink has been provided to the network node by another UE involved in the sidelink.

40. A method of lawful interception (LI) in a communications network, the method comprising:
at a communications network node:
receiving a sidelink connection request from a user equipment, UE, the sidelink connection request including an identification of at least one other UE involved in the sidelink connection;
determining that the UE is a target UE, wherein a target UE is a UE to be monitored for lawful interception (LI) purposes;
informing the target UE and the at least one other UE of a UE-to-UE direct communication interface frequency to use for the sidelink connection;
sending a request message to the at least one other UE, the request message requesting the at least one other UE to provide to the node information about the sidelink connection and a copy of communications data exchanged on the sidelink connection;
sending to an access and mobility management function (AMF) network element (NE) an information message including information about the sidelink connection received from the at least one other UE; and
sending to a user plane function, UPF, network element (NE) content messages, including a copy of communications data exchanged on the sidelink connection received from the at least one other UE;
at an access and mobility management function (AMF) network element (NE):
receiving from the network node information messages containing information about a sidelink connection; and
sending intercept related information messages (xIRI) containing the information about the sidelink connection to a delivery function (DF) for forwarding to a law enforcement management function (LEMF); and
at a user plane function (UPF) network element (NE):
receiving from the network node content messages including a copy of communications data exchanged on a sidelink connection; and
sending content of communication messages (xCC) to a delivery function (DF) for forwarding to a law enforcement management function (LEMF), the xCC including a copy of communications data exchanged on the sidelink connection received from the network node.

41. A lawful interception (LI) system comprising the communications network node of claim 22, wherein
the LI system further comprises:
a communications network device hosting an access and mobility management function (AMF) network element (NE); and
a communications network device hosting a user plane function (UPF) NE.

42. A lawful interception (LI) system comprising a communications network device hosting the access and mobility management function (AMF) network element (NE) of claim 26, wherein
the LI system further comprises a communications network device hosting a user plane function (UPF) network element (NE).

43. A lawful interception (LI) system comprising the communications network device hosting the UPF NE of claim 38, wherein
the LI system further comprises a communications network device hosting an access and mobility management function (AMF) network element (NE).
